(19) United States
(12) Patent Application Publication
(10) Pub. No.: US 2003/0005074 A1
(43) Pub. Date: Jan. 2, 2003

(54) Method of combining shared buffers of continuous digital media data with media delivery scheduling

(76) Inventors: Frederick S.M. Herz, Warrington, PA (US); Jonathan Smith, Princeton, NJ (US); Paul Labys, Logan, UT (US); Jason Michael Eisner, Baltimore, MD (US)

Correspondence Address: Kenneth C. Hill, HILL & HUNN LLP, Suite 1440, 201 Main Street, Fort Worth, TX, 76102-3105, US

(21) Appl. No.: 09/842,477

(22) Filed: Apr. 25, 2001

Related U.S. Application Data
(60) Provisional application No. 60/199,567, filed on Apr. 25, 2000.

(51) Int. Cl. G06F 15/167; H04L 12/26

(52) U.S. Cl. 709/216; 370/229

(57) ABSTRACT

A communications method utilizes memory areas to buffer portions of the media streams. These buffer areas are shared by user applications, with the desirable consequence of reducing workload for the server system distributing media to the user (client) applications. The preferred method allows optimal balancing of buffering delays and server loads, as well as optimal choice of buffer contents for the shared memory buffers.

### CROSS REFERENCE TO RELATED APPLICATIONS

The present application claims priority from U.S. Provisional application 60/199,567, filed Apr. 25, 2000.

### BACKGROUND OF THE INVENTION

1. Field of the Invention

The present invention is in the field of digital communications systems, and more particularly, communications systems which transport continuous digital media such as audio and video.

2. Description of the Prior Art

One of the most important forms of information in digital communications systems is continuous media, exemplified by digital audio and digital video. An example application would be transmission of a movie or live information between a service provider and a user. The traditional method of providing such a service is the broadcast network, exemplified by broadcast television or cable television. Models for future information systems use the concept of integrated services, where voice, video and structured information services such as the world-wide web (WWW) are delivered over a single logical transport service, the packet-switched Internet.

To use such a system, the audio and video information must be encoded in digital form, and packetized. To reduce the use of network resources, the information might be first encoded in digital form and then compressed. The advantage of compression is a significant reduction in data volume, while the disadvantage is the complexity of the algorithms required for encoding and decoding the compressed information. For example, directly encoding NTSC signals from a television system requires about 100 megabits/second of bandwidth, meaning that a two hour video, at 720 megabytes per minute, would require about 100 gigabytes of storage. Encoding the signals using the MPEG 2 compression scheme typically reduces the bandwidth required to about 1.5 megabits/second, or 12 megabytes per minute. With such compression an entire 2 hour movie could be stored in about 1.5 gigabytes of storage. MPEG 2 is designed to require significantly more computation to encode than to decode, as it is presumed that service providers can afford to perform the expensive operations once, in order that the inexpensive decoding operations can be performed many times by receivers. This assumption is clearly true for a stored video, where the encoding is done once and then decoding is done whenever the video is viewed.

When a system is constructed to distribute digitized continuous media to many users, there are a number of attractive opportunities for architectural techniques which can reduce system load in addition to any gains achieved by operations performed on the media such as efficient coding. In particular, a powerful technique is multicast, where the information is not sent to all possible recipients, but rather those who indicate interest, perhaps by subscription. To the degree that sharing can be achieved, e.g., the sharing of a viewing service which plays the video into the network, significant savings can be realized. For example, rather than sending multiple copies of the same video stream, each at 1.5 megabits/second to a significant population of users, the video might be sent once via multicast to the set.

Multicasts are typically represented as acyclic directed graphs called trees, where the server lies at the root of the tree, there are a set of intermediate nodes interconnected by network links which transport information to leaf nodes, at which are located users. A key feature of the intermediate nodes is their ability to replicate information to several nodes in the direction of the information flow, so that eventually the information travels from the server to all interested leaves.

This basic model assumes that the users are all interested in receiving the same information at the same time, e.g., a “scheduled” time for a broadcast event, such as a sports event or a concert. When users join the multicast at some later time, they may lose the first part of the event (which they may be interested in) as it is not saved (or “buffered”). For viewing of archived material, such as replays of videos on demand, the points at which users are interested and start the viewing will vary sufficiently that multiple time-skewed copies of the digital continuous media may be being served to users at any given time.

The difficulties with this situation are two-fold. First, the server is busy sending and resending multiple multicast streams of essentially the same information. Second, the advantages of multicast accrue to the degree that information is replicated—unicast, or point-to-point transmission, can be consider a degenerate case of multicast, and in fact will be the case when there is no shared interest in a continuous media stream. Thus, to the degree in which we can aggregate demand for continuous media streams, we can optimize overall system performance.

### SUMMARY OF THE INVENTION

In accordance with the present invention, a communications method utilizes memory areas to buffer portions of the media streams. These buffer areas are shared by user applications, with the desirable consequence of reducing workload for the server system distributing media to the user (client) applications. The preferred method allows optimal balancing of buffering delays and server loads, as well as optimal choice of buffer contents for the shared memory buffers.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram illustrating multicast over a network;

FIG. 2 illustrates shared use of a buffer;

FIG. 3 is a diagram illustrating use of a double buffer; and

FIG. 4 is a timing diagram illustrating buffer sharing.

### DESCRIPTION OF THE PREFERRED EMBODIMENT

It will be appreciated by those skilled in the art that the following description illustrates techniques that can be utilized in various types of systems. The preferred embodiment is described in the context of an internet system such as is generally known in the art.

Multicast Traffic

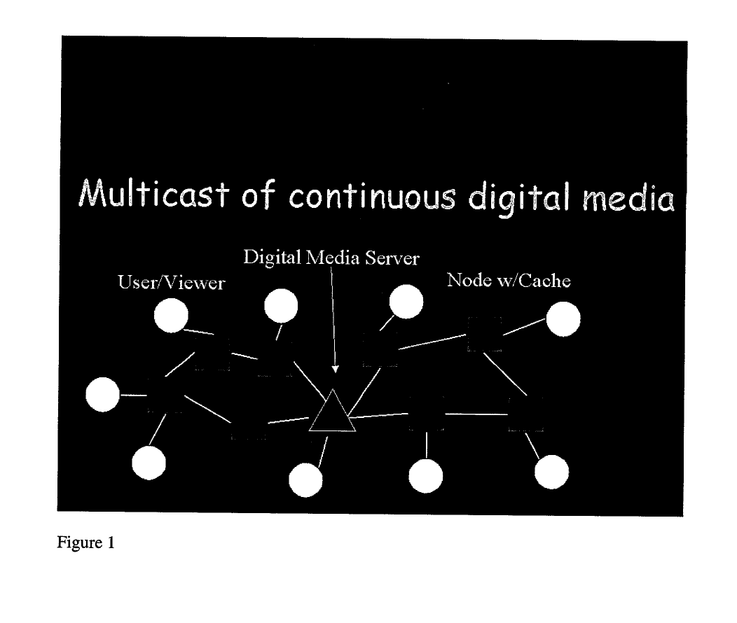

In a store-and-forward packet-switched network, multicast is effected by multicasting the packets of data as they arrive at a node in the multicast tree. In practice, the node is a switch, router or other device which receives a multicast packet on an input port, and sends the packet on one or more output ports in accordance with the topology of the graph describing the multicast of the data to users. A multicast from a server to a number of users is illustrated in FIG. 1.

To perform this operation, the packet must be stored in a buffer memory. In practice, the buffer memory may contain a queue of multiple packets. In the continuous media case, a queue containing a sequence of packets represents a segment of the continuous media stream. When the queue consists of large numbers of packets, substantial storage of media can be achieved within the constraints of the node's memory capacity.

While it is often the case that the buffering is mainly used to effect flow control, that is, to mitigate rate differences between senders and receivers, the presence of buffering capability in nodes allows other optimizations where the buffer capacity, e.g., the queued packets, can be shared or reused effectively. The advantage of sharing and reuse is that once the packet has been transmitted to a buffer, it need not be transmitted from the server to service a user if the user can be satisfied with the buffer contents rather than with an additional independent stream sent by the server.

The difficulty in buffer reuse is independent start times for the multicast streams, as what is in the queue of packets destined to a particular user may not be the same data as that required by another user. To the degree that work (e.g., the transmission of data from one node to another) can be avoided through sharing, the system will perform better. An example of better performance would be more concurrent users operating with a reduction in bandwidth relative to similar systems.

Shared Buffers

Each segment of buffered continuous media represents the result of work done by the network to transport the digitized continuous media to the buffer. Thus, to the degree that the contents of the buffer can be shared, the work of transporting the continuous media to the buffer can be shared. An essential observation is that there is a clear relationship between buffer occupancy and time: each buffer segment of size B bytes represents a playout time of B/R seconds, where R is the encoding rate in bytes per second. A related observation was made in John H. Shaffer, “The Effects of High Speed Netwoks on Wide Area Distributed Systems”, Ph.D. Thesis, CIS, University of Pennsylvania, 1996.

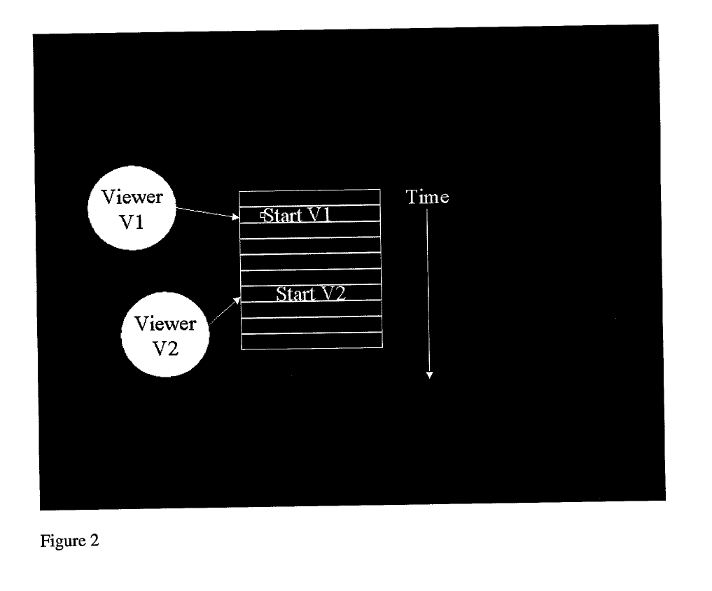

The central observation used in our approach is that if additional viewers arrive within B/R seconds of the start time of the original playout, these additional viewers can utilize the contents of the buffer segment rather than requiring additional network bandwidth for transmission. To be specific, if the arrival time of viewers V1 and V2 is separated by less than B/R, they can share a buffer segment. This is illustrated in FIG. 2.

While a related idea was employed in U. Legezda, D. Wetherall and J. Guttag, “Active Reliable Multicast”, Proc. Infocomm 1998, SF, Calif. to reduce required bandwidth in a reliable multicast, the sharing was different, in that it was used for recovery of lost multicast packets rather than as a support mechanism for multicast of digital continuous media. The key basic point of our method is the use of a per-recipient pointer (an index) into the shared buffer to reflect the differences in start times. By use of this pointer, the buffer contents can be effectively shared.

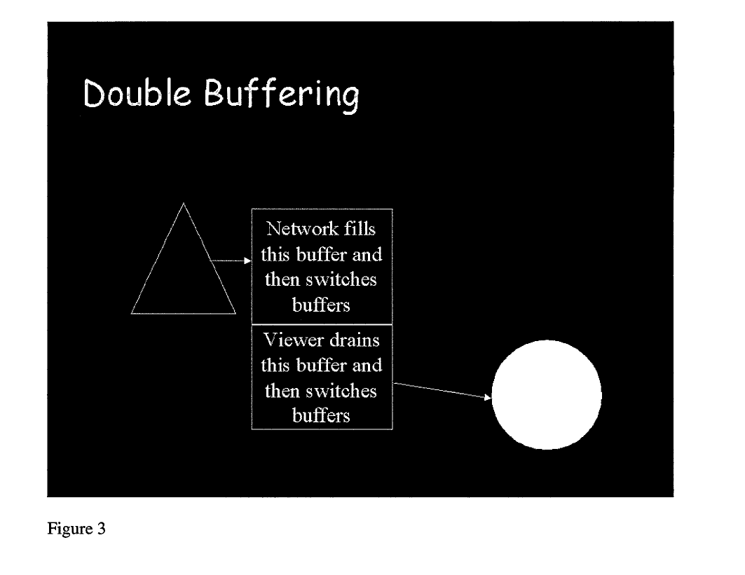

There are a variety of parameters which can be adjusted in the design of such a system. First, to the degree that whole instances of digital continuous media (for convenience, we will call these “files”) can be buffered, there is significant advantage to be had in that the buffer management algorithms are simplified. This is because the algorithms need to spend less effort managing the differences in buffer refresh rate caused by supporting multiple start times. This management cost is incurred if the whole file is not available, as to save bandwidth, the buffer contents must be retained until the last viewer is done with them, i.e., their pointer has advanced to the end of the buffer. This problem is easily addressed if the well-known technique of double-buffering is employed to manage two buffers of size B and the start time deltas are limited to B/R, as above. In the double-buffering technique, one buffer is drained by the viewers while the other is filled from the network, and this solution allows the time-separated viewers to share the 2*B space. The technique is illustrated in FIG. 3.

The same effect can be achieved by limiting the time differences between V1 and V2 to B/(2*R).

Optimal Sharing of a Single Buffer

There are a variety of techniques for buffer management which can make use of the buffer capacity to better store continuous digital media. To review some of the techniques used in U.S. Pat. No. 5,754,938, issued May 19, 1998 to Herz et al, and U.S. application Ser. No. 09/024,278, filed Feb. 17, 1998, both hereby incorporated by reference hereinto, the buffer contents can be:

1. Selected based on statistical modeling of the user based on similarity measures derived from previous viewing.

2. Can be prefetched in advance of viewing demand in order to smooth demands on bandwidth.

3. Can be prefetched in anticipation if possible viewing demand based on similarity measures for the viewers sharing the buffer.

4. Can be retained in anticipation of new viewers requesting the stream based on similarity measures for users sharing the buffer.

While we incorporate by reference the two Herz, et al. patents, we wish to expand slightly here on point 4. This point suggests that the contents of a buffer should be retained even after all current viewers have viewed the content if either there is no demand for the space it is occupying from other content requests, or if the likelihood that it will be used again soon is higher than the likelihood that any prefetched content will be used soon. In effect, the retention decision is one which takes advantage of the fact that a desirable prefetch is already in the buffer. Excepting this observation, the similarity measures and analysis are included by reference to the other patent and filing.

The single buffer case is then optimized by the following algorithm, applied at each discrete time step in the buffer's existence:

1. If the buffer is being used by one or more viewers, examine another buffer.

2. If the buffer has been used recently, estimate the probability that it will be reused in the near future (e.g., a time interval such as B/R). If it is likely, examine another buffer and mark the buffer “RETAINED”.

3. If the buffer is marked “EMPTY”, and a non-“DOUBLED BUFFERED” buffer is being used by the maximum number of viewers, fetch the next B bytes of the continuous media stream into the new buffer to achieve double buffering and mark both buffers “DOUBLE BUFFERED”.

4. If the buffer is marked “EMPTY” and similarity measures show that prefetching more of the stream would optimize performance of the users of the buffer, mark the buffer “PREFETCHING” and request that a continuous media stream of B/R duration be sent to fill the buffer.

5. If a buffer is PREFETCHING and a buffer is required for on-demand traffic, mark the buffer “EMPTY”.

6. If the buffer has been used, and it is unlikely to be reused in the near future, mark it “EMPTY”.

7. If the buffer has not been used, mark it “EMPTY”.

An interesting consequence of this algorithm is that highly popular data will be either completely prefetched or after prefetching and/or viewing, wholly retained. Thus, without explicitly requiring whole file caching, the system will naturally achieve it, and will do so on the basis of statistical usage and estimation measures.

There are additional gains to be made because streams are generally served over relatively lengthy periods of time and are consumed sequentially. This is especially true for such data types as audio and video programming. Because the full stream is delivered to a particular point, it is possible to predict content demand quite precisely for the following minutes or even hours. Moreover, when geographically proximate nodes are conveying the same stream, even at a time shift, it is possible for them to economize on upstream bandwidth.

For example, if node N1 in the network is relaying frames from the FIRST hour of Citizen Kane to one or more downstream users, then the probability is extremely high that it will eventually have to relay frames from the SECOND hour in Citizen Kane, and we can accurately estimate when it will have to do so.

If some nearby node N2 happens to have such frames in a buffer (e.g., N2 is already relaying the second hour), then it is cheap for N1 to get those frames. This cheapness is temporary: N2 isn't going to keep the frames forever, so it may make sense for N1 to immediately copy N2's frames—that is, to prefetch them.

In other words, N1 is getting its stream from the head end, but it is also monitoring N2's stream and caching it for later. Eventually N1 will be able to switch to the cache, at which point it can drop the head end.

Note that the streams don't need to be transmitted at the same speed at which the user will consume them—with additional bandwidth, it would be possible, for example, to send a node the remaining head end of a video stream in a rapid burst. If multiple streams are being fed to a localized cluster of nodes, such a bursting strategy would allow the many streams to be rapidly collapsed into very few (if not one) shared streams, greatly decreasing bandwidth use by the locale.

More complex probabilistic strategies are also possible, with each node participating in a self-organized market, requesting and taking bids for slices of bandwidth.

Optimal System Design with Buffers and Servers

It is obvious that the scheme can be applied to a server with a single buffer. When a more complex system, such as that in FIG. 1 is constructed, the buffers can be viewed as a shared resource and as multiple layers of intermediate capability. In such a system, we can use a hierarchical scheme, so that individual viewers using a single buffer are replaced by multiple viewers sharing a buffer, which in turn shares buffers in the multicast tree. Further, the buffers can cooperate amongst themselves to share caching capacity, and further, the similarity measures of the patents included by reference can be localized to the population of viewers near the particular buffer. In such a case, the population statistics are localized. Caches that are higher in the tree (nearer to the server) aggregate more and more traffic, but have better models of user demand from the aggregated demand of the buffers which are presenting aggregated demand to them.

Additionally, multiple servers can be used. In this case, buffers may communicate with multiple servers based on the demands of their users, and prefetch information based both on user interest and aggregated interest, and capacity of the server being used.

The advantage of these architectural advances for scaling is significant. Information in caches near the edges of the system is localized to the user interests represented by the similarity measures applied to the continuous digital media or descriptive information associated with it. Each level of buffering in the hierarchical multicast demand aggregates various levels of interest and optimism in prefetching data: data prefetched by many buffer caches on behalf of their clients/viewers will be more likely to be buffer resident where higher levels of aggregation ensue.

VI Demand Aggregation of Data Streams as an Optimally Bandwidth Conserving Form of Pre-Fetching

The following technical methodology describing similarity-informed pre-fetching (the subject of a co-pending patent application by the inventors of the presently disclosed invention) provides an underlying technical framework for the object of the novel innovative concept introduced within this section which is the aggregation of data streams based upon capitalizing upon aggregate demand prediction of a sub-population of users who are imminently likely to request a particular file (a standard file or a streaming file). Similarity-informed pre-fetching provides a fundamental technical basis for demand aggregation of down-loaded data streams with a few fundamental differences as are explained further below.

Bandwidth is greater at the root end of a hierarchical node network system, in anticipation of a request, it is prudent to use the similarity measure to predictively cache files into local servers and further to narrow-cast selections into given distribution cells and (hierarchical) sub-cells through sub-servers based on what selections are most likely to be requested in each cell so as to significantly increase the utilization of bandwidth via this hierarchical narrow-cast configuration. The importance of this savings appears in proportion to the degree of granularity (smallness of the cell) in the narrow-cast architecture. This technique can also be used to make decisions for scheduling what data should be placed on dedicated channels. This may be more network-efficient if a file were popular enough to be continuously in the queue because upon submission of a request a file may be partially downloaded regardless of where in the length of the file the download began. The (initially) missed portion of the file can then be immediately picked up as the file narrow-cast starts over, thus completing the download in the same time period as if a special request for the file were made. Mobile users whose geographic locations are known can have files pre-cached (e.g. at night) into the servers which are presently physically closest to them at any given time.

The present data distribution system employs the idea of pre-fetching, which has also been referred to as pre-caching, cache-pre-loading, or anticipation in the technical literature. The basic idea is that if good predictions of future data requirements are available, and there is excess data-fetching capability available, the data should be fetched aggressively in anticipation of future needs. If successful, this technique has two major benefits applicable to present and future networks. First, it can reduce (i.e., improve) response-time, a major performance advantage in interactive systems. Second, it can reduce congestion and other problems associated with network overload. To understand how the responsiveness of the system is improved, the unused bandwidth can be used to transmit information likely to be used in the future. For example, if a list is being traversed 1,2,3,4, it is likely that if object N has been requested, that object N+1 will be the next request. If N+1 is pre-fetched from the remote system, it will be available when the request is made with additional delays. All of the “UNUSED BANDWIDTH” can potentially be used to pre-fetch.

Within the context of the pending patent on the pre-fetching concept entitled “Broadcast Data Distribution System with Asymmetric Uplink/Downlink Bandwidths” one of the key objectives is it involves the use of pre-fetching as a congestion control technique as if we pre-fetch successfully during more lightly loaded periods (such as TIME=0.42), we reduce the probability of data being requested in the futures, essentially trading the guarantee of a fully loaded network today for the promise of no congestion in the future. By fetching data in anticipation of future needs, we reduce (at least probabilistically) those future needs.

Pre-fetching has been used in the computer operating systems field for several decades, and a variety of algorithms have been explored. A. J. Smith of Berkeley has reported that the only case where successful predictions about future requests for memory objects can be made is when accesses are sequential. More recent work for higher-level content such as World-Wide Web (WWW) hypertext has shown that user-authored links to other hypermedia documents can be followed with some success.

The pre-fetching technology which the inventors of this disclosure have previously invented is based on unused slots being filled with pre-sent information based on our understanding of user interest using the similarity measures developed in the issued patent entitled “System for Generation of User Profiles for a System for Customized Electronic Identification of Desirable Objects” (U.S. Pat. No. 5,754,939) and used for our prioritization (see p. 18 of the above-referenced invention disclosure), a concept that they do not deal with, as they follow http: links based on observations about the high probability that these links will be followed by users.

The pre-fetching invention may be usefully applied within the context of set-top box like devices such as personal digital assistants or network computers, or personal computers used as a form of set-top box as well as any type of “fat client” as a method of reducing response time as observed by users. This method used “links” to other documents embedded in an HTTP-format file as hints that those links should be followed in pre-fetching data; that is, the linked documents should be fetched in anticipation of the user's desire to follow the links to those documents.

The present invention provides two enhancements to this scheme. First, it provides a technological means by which the pre-fetched data can be intermixed with on-demand data to provide overall improvements in response time to a large population of HTTP/WWW users, with reduced memory requirements. Second, t-he present invention, which views the down-link as a fixed capacity resource, provides a general scheduling method embodying techniques such as user preferences to pre-fetch when slots or bandwidth are underutilized, to preemptively reduce future demand for bandwidth.

In addition, the similarity measures which suggest:

1. An anticipated behavioral similarity between different though metrically “similar” users may be used to further analyze other previous user's on-line behavior as well as,

2. Page similarity to other links, which the user has an explicitly or implicitly (predicted) affinity towards, may be a technique to further improve predictive accuracy as to which of the available links the user is probabilistically most likely to imminently select next (compare to aggregatively using the overall popularity of those links).

The general technique of using similarity-informed pre-fetching is described at length in U.S. patent entitled “Pseudonymous Server For System For Customized Electronic Identification Of Desirable Objects”, U.S. Pat. No. 5,754,938 filed Oct. 31, 1995, issued May 19, 1998.

The technique of data-streams is based upon a similar variation of the type of similarity-informed pre-fetching, which is performed on a relatively dynamic basis as suggested below. A couple of fundamental extensions to the basic technique are added, however. Unlike dynamic similarity-based pre-fetching, because there is a certain degree of predictive error, which invariably occurs though the present techniques attempt to anticipate imminently forthcoming file requests on the part of the user (and where the error rate exponentially increases in proportion to the length of the anticipatory period), the basic goal of this dynamic pre-fetching is increasing speed of user access to page requests at the expense of the additional bandwidth, which is consumed as a result. However, in the case of data stream aggregation the key objective is to minimize bandwidth utilization. This approach also results in the ability to not adversely affect speed of access to the data. Although its use is in no way limited, it is likely that the present approach to pre-fetching basic data stream aggregation may be particularly well suited for delivering data to the leaf end nodes of the network

Compared to similarity-based pre-fetching, the key modification in the basic method (and certainly technical challenge) of pre-fetching based data stream aggregation is the following:

In similarity-based dynamic pre-fetching (as suggested above), the similarity measurements of the predictive data model anticipates, on a dynamic basis, the forthcoming file request actions of the user. In fact the outputs, i.e., probabilities of a given user requesting any given file, can be measured as a function of time (T). If this measurement is based upon the entire subset of that user population which has at least some non-zero probability of imminently selecting that file, we, in turn, may determine the aggregate probability of that file to be requested by the entire user sub-population (i.e., which is serviced by a particular data distribution server) as a function of time. Of course, in accordance with the probabilistic model, this aggregate probability curve (of average likelihood of the user population to initiate the request) changes on a moment to moment basis changes in accordance with further behavioral feedback of the sub-population as time (t) approaches the average (probabilistically most likely) time for overall demand for that file to culminate (however, this value remains fixed for our purposes as once a pre-fetching decision has been made any subsequent probability shifts are irrelevant). The point in time at which a data stream is scheduled to initiate is T₁ and the end is T₂. There is another important relationship which is within a given average probability measure the actual time from the point in time which is that moment that the user population on average is anticipated to actually request the file. We will call this value T_{b1}. The end of that period is called T_{b2}. We want to also determine the average effective available memory of each relevant user's client's local buffer, however, this value is also affected by such variables which compete for this space such as how much of this memory had been pre-allowed to long-term pre-fetching (the relative proportions of such allocation of which would be determined through experimentation and may be network specific) and how much “risk diversification” is provided for i.e., the probability distribution for any given individual at any give instant in time (t) preceeding an actual request is very likely to contain secondarily another (or other) file(s) with some non-zero probability. Thus the total probability (and possibly relative probability) determines available buffer memory for the present anticipated file request. For purposes of the present estimation, this value is called ΔT_{b} and is measured as the amount of time that the present effective available memory buffer for that client is able to receive the data stream associated with the present anticipated forthcoming request.

We then want to select a time T to actually request the file for delivery to all the relevant users U based upon the average of the product of probability (of making the desired relevant file request) (P_{b}) and time such that T₁'s value is such that period.

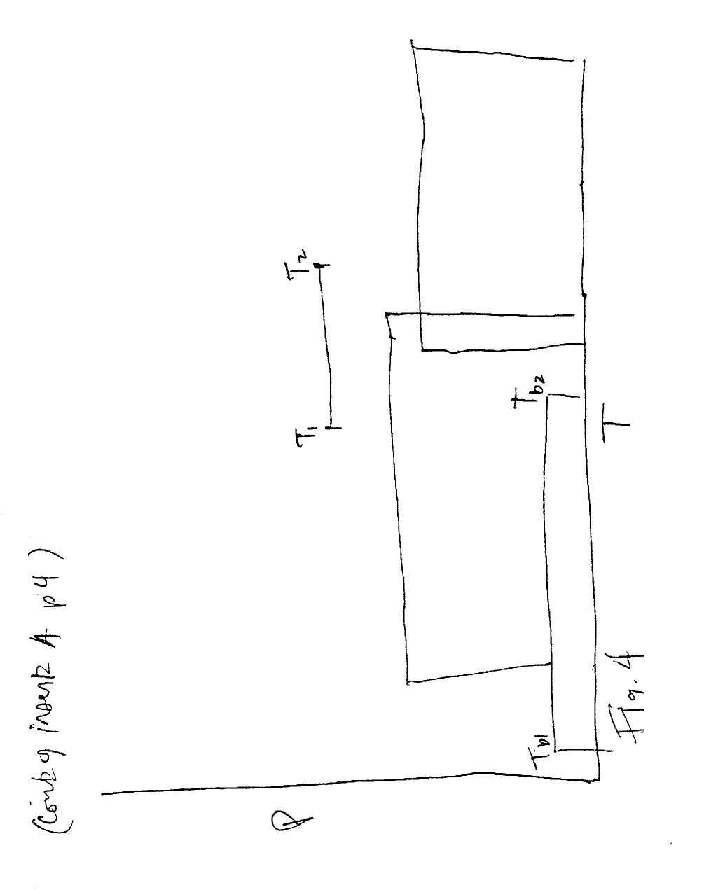

T₁−T₂ provides the maximum possible product of probability and time for all relevant clients' buffers collectively (that are able to concurrently co-exist within period T₁−T₂). (the fixed value describing the period of the data stream) Based upon these variables the key technical challenge of pre-fetching-based data stream aggregation is determining values of T₁−T₂ which achieve optimality in reducing bandwidth consumption in the multi-cast of that particular data stream. This is represented in FIG. 4 by our attempt to find a T₁ value optimizing the area described by probability and time within the T₁−T₂ period. The following equation is provided:

(T₁−T₂)={ΔT_{b}P_{b}Z+(ΔT_{b}+1)(P_{b}+1)(Z+1)+. . . }(mean average)

where Z is the percentage of T_{b1}−T_{b2} which overlaps with T₁-T₂.

FIG. 4 depicts graphically how a key objective of the above equation is to find a T₁−T₂ value which maximizes the (2 D) area under the various client buffers collectively in a probability time graph.

Finally, in light of the present technique because the predictive models are prone to a certain degree of oversight, i.e., not anticipating the forthcoming request actions certain uses for a given file or not the accurate timing therefore (e.g., not anticipating the request action soon enough) there will invariably exist certain inefficiencies in the present model in which certain user request data streams are not properly (or not at all) aggregated, thus, we would like to provide yet another additional solution to more efficiently aggregate these inefficiently transmitted streams. The idea is that if a local client buffer has failed to initiate download of a stream (or has initiated it after its initialization, we can effectively re-transmit the “missed” portion of the stream to the new requester at a very fast rate (e.g., if it is streaming media content, considerably faster than real-time) up until the point in which the data received by the new requester “catches up” with the original stream at which time both the new requester and original requester(s) then share the same stream for the remainder of its duration. In such an event the bandwidth utilization specifically allocated to that missed portion of the file we could say becomes “bursty”. Due to the somewhat different mechanism of both data stream aggregation methods, in trying to achieve optimal bandwidth utilization the degree to which this additional approach to aggregation should be relied upon compared to the original pre-fetching based approach (that is to say from a probabilistic standpoint how speculatively do we want to pre-fetch versus rely upon effectively the present (“fall-back”) approach of using burstiness of transmission to compensate for the resulting “missed” requests of the predictive (anticipatory) approach. This balance between the degree of utilization of these two methods my also be a bit subjective in as much as if bandwidth is (presently) overly constrained, the system may automatically adjust by relying more heavily upon the original technique of pre-fetching based data stream aggregation (and certainly even more towards artificial delays in as much as bursty data stream aggregation while involving no delays in initiating does involve some degree of extra bandwidth utilization during the “bursts”. Of course, as part of this pre-fetching procedure and (relatedly) the ) the number of files provided a given probability distribution for forthcoming requests of those files must also be determined through further experimentation.

In another form of data stream aggregation called “artificial delays”, described further below, speed of access to the user is invariably compromised in direct proportion to the degree of data stream aggregation which is desired for reducing bandwidth. In the presently described version of data stream aggregation (as is also true in the case of artificial delays), although it may be variable, on the average, the number of users serviced by the data distribution server as well as the degree of popularity of the particular file being presently requested by the user relative to that particular population of users, is directly proportional to the speed of access by the user to that particular requested file. Accordingly, non-dynamic pre-fetching (also detailed above), because it is both non-dynamic in nature and also achieves a reduction in overall network traffic can be used in combination with the present pre-fetching based data stream aggregation in order to provide an optimally efficient traffic reduced network environment, and as is further described below there are further bandwidth reduction optimization techniques which allow for the approach between the intermediate node and leaf end of the network while allowing for non-dynamic similarity-informed pre-caching and the most bandwidth efficient data stream aggregation technique, i.e., artificial delays to occur on nodes close to “trunk” portion of the network where the potential number of user connections represented is extremely large and thus potential for bandwidth conservation, using artificial delays is extremely great. On the other hand, if near the leaf end of the network further bandwidth conservation is desired, it is even possible to provide the technique of artificial delays in combination with static pre-caching and dynamic pre-fetching based data stream aggregation. And this approach may be particularly compelling in achieving substantial bandwidth conservation if the end-user population (or number of network “leaves”) is quite large.

Artificial Delays

This note discusses the notion of “artificial delays” in the queuing of requests for the satellite or cable system to which our set top boxes are attached. The idea is that by careful management of the queues, we can effect significant bandwidth savings for the system as a whole. If you will remember, the Server scheduling algorithm (I've attached the text for it from the DBS scheme I sent during the Summer at the end of this e-mail) goes like this:

The client set-top box (of which there should be many) sends REQUESTs for information in cell-sized units to the server system. The server system applies a priority algorithm (see especially Step 10, below) to CHOOSE the next cell to send. By design of the relative priorities, we can get good responsiveness and reduced bandwidth needs, in spite of the low memory needs (and low cost) of the set top boxes.

Imagine the scenario where there are MANY set tops connected to the server. This situation might be where the Cs are Clients and the S is a Server. Now clearly, there is a multiplicity of Clients, and by virtue of this multiplicity, we may be able to achieve a savings through appropriate delays. I again believe the similarity measure is the key to success here, and to novelty. Consider the cell requests for Clients C1, C4 and C5, shown below using letters to indicate particular cells as discussed in our disclosure text.

C1: E-T-A-O-I-N-S-H-R-D-L-U . . .

C4: N-A-T-I-O-N-A-L-V-E-L . . .

C5: E-A-T-O-N-L-Y-S-U-D . . .

We mark these cell request with times associated with their transmission intervals:

T:

I:0000000001111

M:1-2-3-4-5-6-7-8-9-0-1-2-3 . . .

E:

Now, for convenience, assume that all of the cell requests show above have the same priority. Then the server might actually send the following sequence of cells over the channel:

S:E-N-E-T-A-A-A-T-T-O-I-O . . .

Thus, we are servicing the cell requests C1-C4-C5-C1-C4-C5 . . . (in fact, the Server may notice the overlaps between requests by C1 and C5 in the first interval, C4 and C5 in the second interval, C4 and C5 in the third interval, and C1 and C5 in the fourth interval, giving:

S:E-N-T-A-A-T-O-I-I-O-N-N . . .

)

Imagine that the clients are always listening. Then, we can delay cell requests in the HOPE that the REPLYS can be MERGED, satisfying multiple set-top-box clients with the same REPLY. To make this concrete, consider delaying service by one period. So the output of the server then looks like:

S:#-E-N-T-A-O-I-N-L-S-A-Y . . .

What is going on here is very subtle. By delaying some clients service requests, we are INCREASING THE PROBABILITY that another such request will come in, which can we can fold into service of the equivalent delayed request. The cost is potentially in delay, but with enough overlap, the cell times are short enough for 48 byes on a DBS channel that we can probably delay significantly.

Considering the problem theoretically for a moment, we can compute the gain for the an acceptable delay D as being the number of redundant transmissions which are eliminated due to a delay D. So, for delays of from 1 to 10 cell times the total number of DBS cells without redundancy checks is 30; the number required when this small optimization is applied is as shown below:

Delay DBS CellsBandwidth Savings

02430/24=25%

11830/18=66%

21730/17=76%

31730/17=76%

41530/15=100%

51530/15=100%

61530/15=100%

71530/15=100%

81530/15=100%

91530/15=100%

101430/14=114%

We compute the bandwidth gain against the dumb use of 30 cell times; the bandwidth gain comes from the fact that the synchronous satellite channel gives us a fixed bandwidth, giving a fixed number of cells per unit time, and we have just saved 16 cell times by use of the delay scheme. For this example, at this point no more gain is possible, since all the duplication has been eliminated. In some sense, this behaves like a compression scheme. The similarity algorithm increases the probability that these overlaps will occur—the ideal situation is we are waiting long enough so that the scheduled broadcast cell satisfies almost all requests for that cell within a significant time intervals (say several milliseconds).

Optimal Stream-Handling Techniques as a Function of Node Location in the Network.

The method by which streams are handled depends in part on a node's location in the network.

A node close to the network's “trunk” will often be best served by artificial delays and pre-caching techniques, whereas nodes closer to the network's “leaves” more efficiently make use of demand aggregation and pre-fetching.

The particular topology of a given network will determine the distance a node must be from the center in order for the “leaf” approaches to be more appropriate than the “trunk” approaches.

Long-Term vs. Short-Term Pre-Caching Due to the relative importance of responsiveness compared to relative bandwidth savings opportunities at the edges (leaf ends) of the network compared to the trunk, dynamic pre-fetching (and pre-fetching-based data stream aggregation) may be efficiently utilized near the network edges while more static (long-term) pre-caching )may be more appropriate closer to the trunk nodes of the network. Also at this trunk level because the number of repetitive requests artificial delay based data aggregation is very efficient and because of the rather large storage capacity associated with this repetitive file traffic, long-term pre-caching is certainly ideal.

Automatic Adaptive Shifting to Other Techniques

E.g., if/when traffic congestion and slow down at the edges occurs, it may be prudent to shift the relative degree of utilization of one technique to another, e.g., in the present scenario the use of artificial delays may be able to significantly reduce delays through relieving congestion. Pre-fetching-based data stream aggregation may also provide useful advantages.

As a result, different levels in the network have different traffic and storage characteristics (and relative responsiveness priorities). The selection and relative dependence upon one of the above techniques versus another may be different at these different levels and the desirable optimizations requiring different uses and priorities of these various techniques may change at any given level in the network and at any given time based upon these dynamically changing characteristics of the network traffic (to the extent that these dynamic characteristic changes are not pre-determinable using existing network traffic intelligence solutions).

Likewise, because both probability and statistical confidence (degree of certainty) varies even between different files which are predictively anticipated (using pre-fetching-based data stream aggregation), the use of this method (the degree of reliance) of this method, may vary even between anticipated file requestion, e.g., it may be advantageous if the probability of a file being requested is low or the statistical confidence of a file (even the most “likely” file) to make the anticipatory period for requesting that file low (i.e., less speculative) in order to rely more upon bursty data stream aggregation (or artificial delays particularly in these latter two techniques the period of anticipation may be ideally further minimized if/when these other techniques are utilized with higher relative importance.

Consideration for Pre-Fetching Based Data Stream Aggregation

In addition, because data stream pre-fetching aggregation is a very important technique for providing bandwidth conservation (an important need for the leaf ends of the network), while also providing a high degree of responsiveness to requests, it may also be important to insure that the appropriate technique (or combination of techniques) as suggested above is utilized to insure that files reach this bandwidth bottleneck in the network, (e.g., the intermediate node just prior to leaf end node) such that pre-fetching data stream aggregation at this level can occur extremely efficiently without uneccessary efficiency consequences resulting from delays higher up in the network (e.g., this may be especially true in the case of the wireless network example).

Additional Considerations

1. Streaming vs. Static Files

This description has been focused mainly on streaming types of data. However, packet analysis at the backbone level could identify metrically close data transmissions of any sort (that is, streaming or static (“static” meaning non-streaming). Thus, when two proximate nodes download the same extremely large data file of a non-streaming sort, they could use a shared buffer to reduce their external need of bandwidth to a single connection. In the end, this architecture handles files of both the streaming and static types in very much the same way.

2. Tradeoffs between Bandwidth and Memory

In all of these examples, there is a continuous tradeoff between bandwidth and memory: if a great deal of bandwidth is available, there is little need for localized buffers—every user can afford an individual real-time connection and therefore has no need to store any streams. On the other hand, if a great deal of memory is available, the permanent storage of all incoming streams to a local server would eventually reduce the need for external bandwidth.

Exemplary Applications

The network architecture described in this patent can be embodied in many relevant applications. Note that although a few are described here, the architecture is generally applicable to any situation in which multiple proximate (relative to the network) users will potentially access the same stream of data within some period of time.

1. Neighborhood Server

A subdivision of homes is linked by high-bandwidth lines to a shared, local server which acts as the neighborhood's central portal to the Internet. Using residents' video preference profiles, the server predicts which movies or television programs are most likely to be requested as downloads, and buffers (for example) the first ½ hour of the 50 most likely selections to local memory. This could best be done during the day, when residents are more likely to be at work, temporally smoothing the neighborhood's demand for bandwidth.

In the evening, if a resident happens to select a video stream which has already been front-loaded in the local server, he is sent data directly from the local buffer. If no other resident requests the same program, the single user is switched to an external stream when the buffer has been exhausted. However, if several residents select the same program at roughly the same time (that is, within the ½ hour buffer), the server continuously downloads (and buffers) a window of streamed data that spans the users' timings. For example, Resident A starts watching Citizen Kane; for the first ½ hour he is initially fed a stream from the local server. Suppose 5 minutes later Resident B also starts to watch Citizen Kane. When A reaches the end of the ½ hour buffer, the neighborhood server starts to draw Citizen Kane as a stream directly from the internet, pushing it to A directly, and then saving the stream to a continuously-refreshed five-minute buffer. B is fed from the end of the buffer, just before the stream is finally cleared from memory. In this way, rather than opening two high-bandwidth connections to the Internet, the local neighborhood server needs only open a single high-bandwidth connection and allocate enough memory in its local buffer to hold five minutes of video programming. When multiple residents watch the same programming at fairly similar times, this method greatly reduces the subdivision's overall need for external bandwidth.

Note too that peer-to-peer (P2P) methods could be used to expand the neighborhood's available storage—the neighborhood server would be given permission by residents to temporarily make use of memory or hard disk space that they are not currently using on their own home machines. This would expand the number of stream front-ends that could be prefetched.

2. Demand Aggregation for Wireless Electronics

Demand aggregation techniques would also be useful in the case of wireless devices—if many users in a particular locale exhibit similar data needs (such as Wall Street executives checking popular stock prices periodically), bandwidth could be conserved by continuously sending the information in a single stream to a server connected to the local wireless transmitter.

3. Optimization of Web Page Delivery

While a user peruses a given Web page, it would be possible to prefetch many of the pages to which his current page is currently linked. Then, when the user clicks a hyperlink, because his selection is already in the local buffer it can be delivered almost instantly. Obviously, this could be made more sophisticated, with probabilistic methods used to determine which pages are most likely to next be chosen by the user, and thus which are the most logical candidates for prefetching.

While the invention has been particularly shown and described with reference to a preferred embodiment, it will be understood by those skilled in the art that various changes in form and detail may be made therein without departing from the spirit and scope of the invention.

What is claimed is:

1. A method for reducing bandwidth utilization in a system for distributing digital continuous media information from one or more servers, where users of the system are connected to a shared continuous media buffer and the buffer is shared amongst the users based on usage, consisting of the steps of:
i.. The user requesting a continuous media stream from the server;
ii. The server periodically sending encoded packets to the user representing portions of the media stream;
iii. A buffer shared by multiple users capturing the packet into one or buffers for redistribution to the user.
iv. Servicing later requests arriving within a bounded interval for the same buffer.
